(19) United States
(12) Patent Application Publication
(10) Pub. No.: US 2017/0017991 A1
(43) Pub. Date: Jan. 19, 2017

(54) METHOD AND SYSTEM FOR ADVERTISING BASED ON PREDICTIVE SURVEY PARTICIPATION PATTERNS

(71) Applicant: iPerceptions Inc., Mntreal (CA)

(72) Inventors: Lane Cochrane, Kirkland (CA); Matthew Butler, Seattle, WA (US)

(21) Appl. No.: 14/798,082

(22) Filed: Jul. 13, 2015

(51) Int. Cl. G06Q 30/02

(52) U.S. Cl. CPC G06Q 30/0245; G06Q 30/0277

(57) ABSTRACT

Method and survey server for generating an indicator of predicted survey participation data. Survey participation data are collected from a plurality of user devices. The survey participation data correspond to survey information received from users of the user devices in relation to visiting a specific website. Online profile data are collected for the plurality of user devices. The online profile data comprise at least one attribute representative of an online activity of the users of the user devices. The survey participation data and the online profile data are analyzed to generate predictive survey participation patterns for the specific website. An indicator of predicted survey participation data is generated for a current user device in relation to the specific website, based on current online profile data received for the current user device and the predictive survey participation patterns. The indicator is used by an advertisement server for advertisement selection.

### TECHNICAL FIELD

The present disclosure relates to the field of website analytics via web surveys. More specifically, the present disclosure relates to a method and survey server for advertisement selection based on predictive survey participation patterns and online profile data.

### BACKGROUND

The usage of websites to make dedicated web content available to a large public is now prevalent, in relation with the widespread usage of fixed Internet access and mobile Internet access. In particular, e-commerce has become a major component of the economy, in a plurality of business areas such as for example travel agencies, on-line banking, consumer electronics and multimedia retail sales, etc. Websites in relation to professional services and administration are now also widely used to reach prospects and users.

There is a growing need for the owner or administrator of a website to better understand whether the visitors are satisfied with their interactions with the website, and to rapidly detect and identify operational issues affecting the user experience of the visitors. One way to obtain such information is to invite some of the visitors to participate to a web survey during or after the browsing of the website. By gathering answers to the web survey over a panel of visitors, the user experience with respect to the visit of the website can be evaluated. Similarly, an original intent of the visitors for visiting the website can be determined via the web survey.

However, survey participation data are only available for a fraction of the visitors who visited the website (the visitors who were invited to participate to the survey, and who further accepted to participate to the survey). For the visitors for whom survey participation data are not available, it would be beneficial to generate predicted survey participation data based on other available data. For example, behavioral data can also be collected with respect to the visited website, and correlated to the survey participation data when those are available. Thus, when no survey participation data are available, they can be predicted based on the available behavioral data and the generated correlations. However, behavioral data may not be available for a particular website. Additionally, behavioral data may not be accurately correlated with corresponding survey participation data for a particular website. Thus, it may be advantageous to use complementary data which are not solely related to the website for which the survey participation data are collected, in order to generate the predicted survey participation data.

There is therefore a need for a new method and survey server for generating predictive survey participation patterns using online profile data. The generated predictive survey participation patterns can then be used in different contexts, including online advertising.

### SUMMARY

According to a first aspect, the present disclosure provides a survey server. The survey server comprises a communication interface for exchanging data with user devices. The survey server also comprises memory for storing predictive survey participation patterns. The survey server further comprises a processing unit for collecting survey participation data from a plurality of user devices. The survey participation data correspond to survey information received from users of the plurality of user devices in relation to the visiting of a specific website. The processing unit also collects online profile data for the plurality of user devices. The online profile data comprise at least one attribute representative of an online activity of the users of the plurality of user devices. The processing unit further analyzes the survey participation data and the online profile data to generate predictive survey participation patterns for the specific website. The processing unit receives current online profile data for a current user device. The current online profile data comprise at least one attribute representative of an online activity of a user of the current user device. The processing unit further generates an indicator of predicted survey participation data for the current user device in relation to the specific website, based on the current online profile data and the predictive survey participation patterns.

According to a second aspect, the present disclosure provides an advertisement server. The advertisement server comprises a communication interface for exchanging data with other devices. The advertisement server also comprises a processing unit for receiving an indicator of predicted survey participation data for a current user device in relation to a specific website from one of: a survey server or the current user device. The indicator of predicted survey participation data is generated by the survey server based on current online profile data of the current user device and predictive survey participation patterns for the specific web site generated by the survey server. The processing unit further selects an advertisement directed to the current website for the current user device, based at least on the indicator of predicted survey participation data.

According to a third aspect, the present disclosure provides a method for generating an indicator of predicted survey participation data. The method comprises collecting, by a processing unit of a survey server, survey participation data from a plurality of user devices. The survey participation data correspond to survey information received from users of the plurality of user devices in relation to the visiting of a specific website. The method also comprises collecting by the processing unit online profile data for the plurality of user devices. The online profile data comprise at least one attribute representative of an online activity of the users of the plurality of user devices. The method further comprises analyzing by the processing unit the survey participation data and the online profile data to generate predictive survey participation patterns for the specific website. The method comprises receiving by the processing unit current online profile data for a current user device. The current online profile data comprise at least one attribute representative of an online activity of a user of the current user device. The method further comprises generating by the processing unit an indicator of predicted survey participation data for the current user device in relation to the specific website, based on the current online profile data and the predictive survey participation patterns.

### BRIEF DESCRIPTION OF THE DRAWINGS

Embodiments of the disclosure will be described by way of example only with reference to the accompanying drawings, in which:

FIG. 1 illustrates a system for generating predictive survey participation patterns using online profile data;

FIGS. 2A and 2B illustrate a method for generating predictive survey participation patterns using online profile data;

FIGS. 2C and 2D illustrate the use of an indicator of predicted survey participation data for advertising;

FIG. 3 illustrates an example of a web survey for collecting a user intent in relation to a visit of a website;

FIG. 4 illustrates an example of data collected by a survey server represented in FIG. 1; and

FIG. 5 illustrates the system of FIG. 1 further comprising an advertisement server.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

Various aspects of the present disclosure generally address one or more of the problems related to the generation of predicted survey participation data in relation to a specific website for a user device, when no survey participation data are collected from the user device in relation to the specific website.

The following terminology is used throughout the present disclosure:
Web survey: A web survey aims at collecting user feedback related to a visit of a website by a user. The term survey is used in a generic manner, and may include surveys, questionnaires, comment cards, etc.

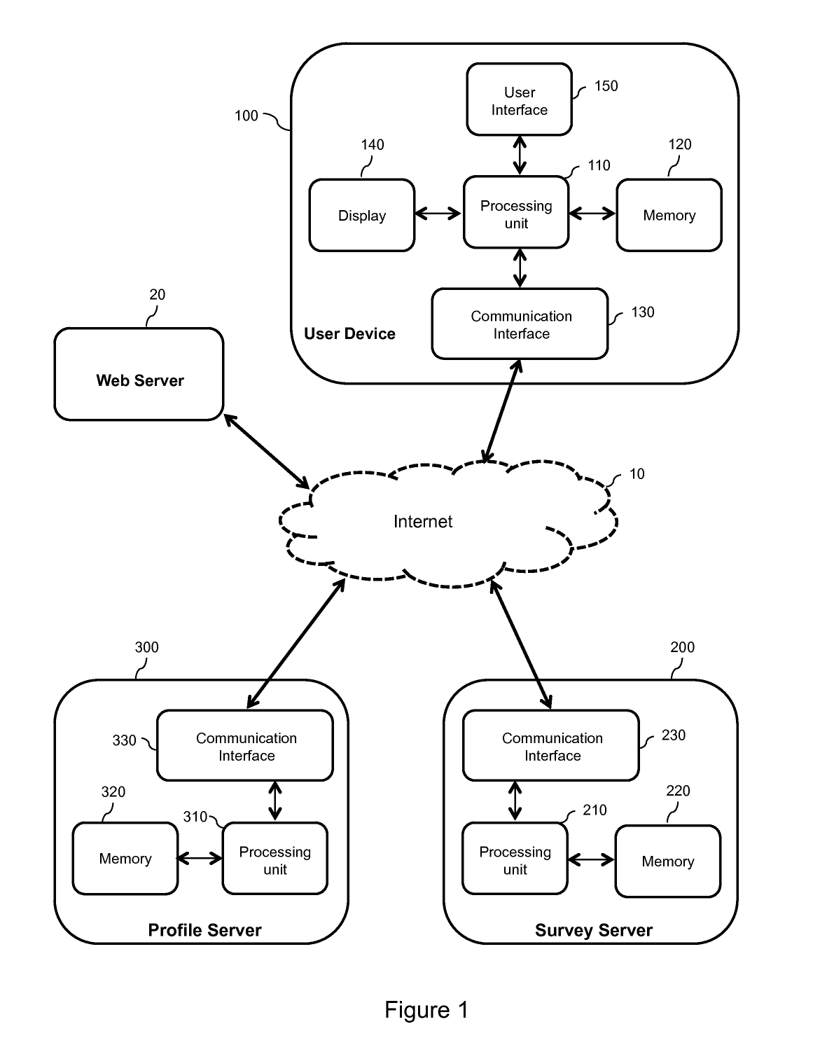

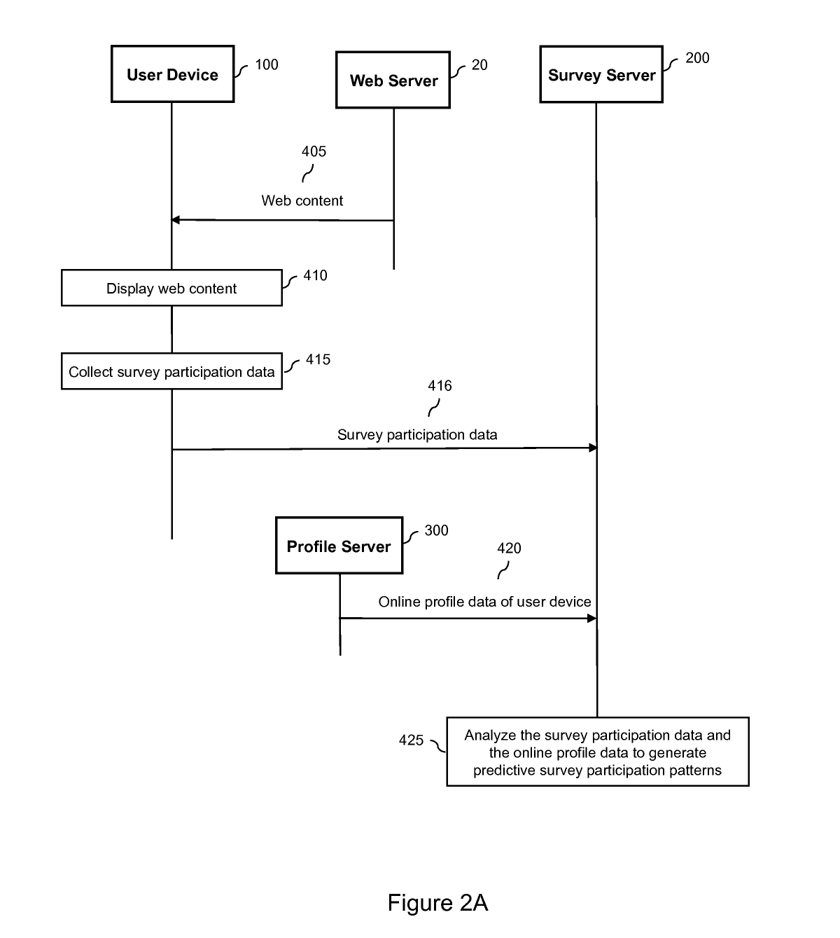

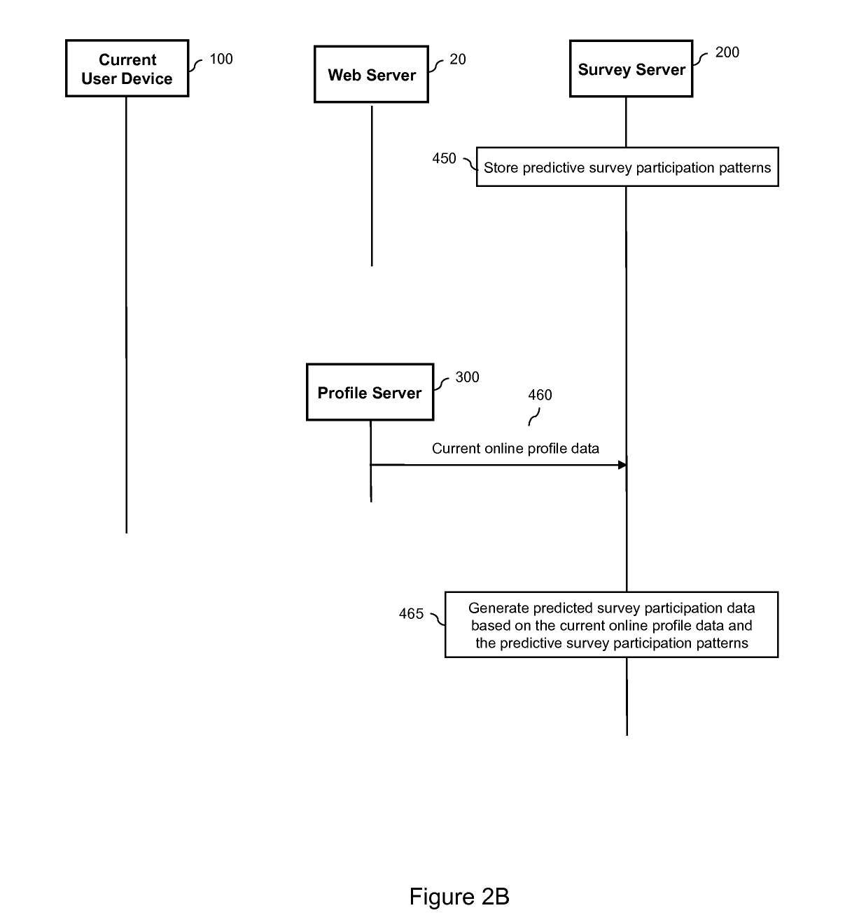

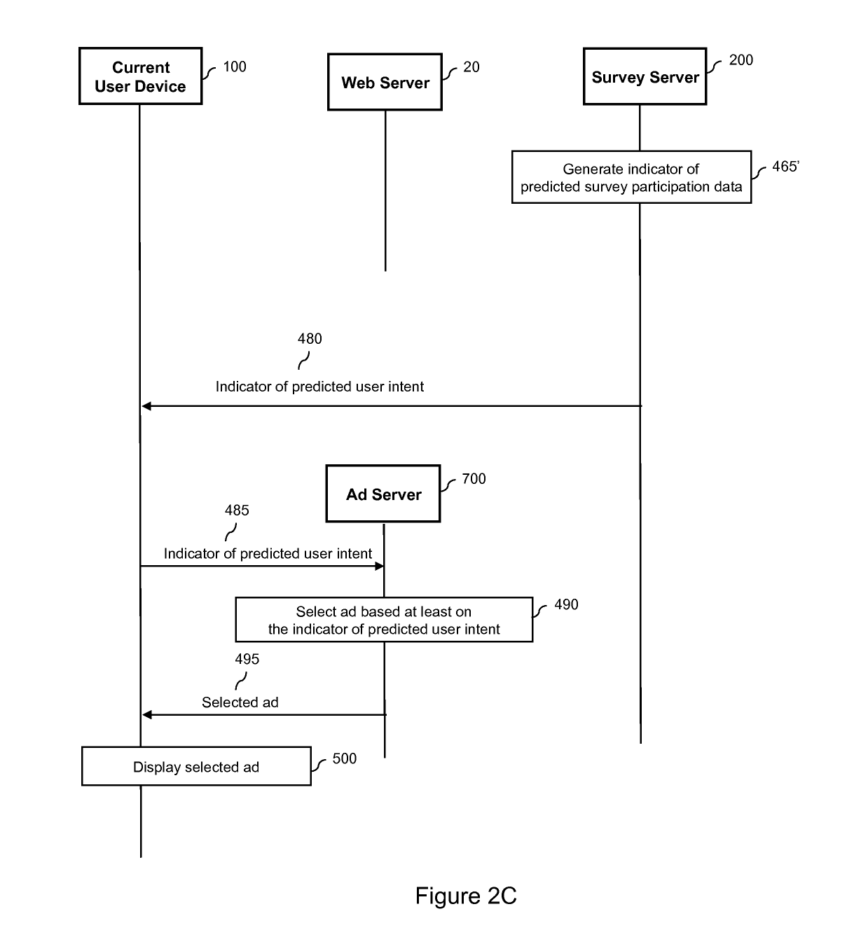

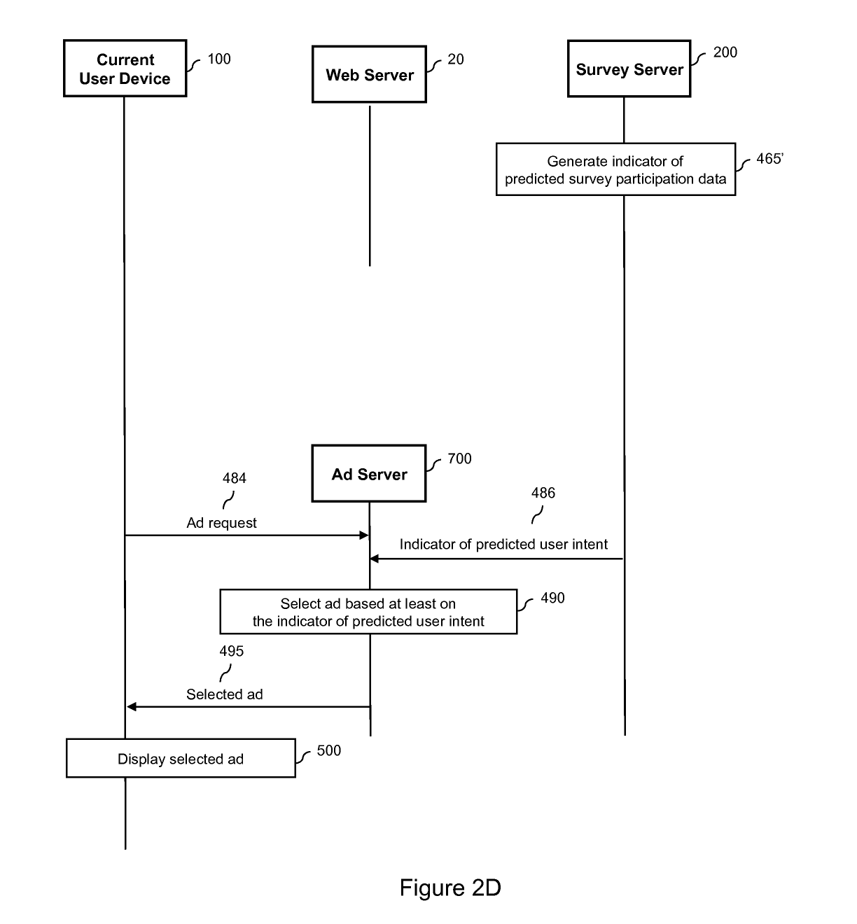

Referring now concurrently to FIGS. 1, 2A and 2B, a system and a method for generating predictive survey participation patterns using online profile data is represented. The system comprises a survey server 200 and a profile server 300. At least some of the steps of the method 400 are performed by the survey server 200.

The survey server 200 comprises a processing unit 210, having one or more processors (not represented in FIG. 1 for simplification purposes) capable of executing instructions of computer program(s). Each processor may further have one or several cores. The survey server 200 also comprises memory 220 for storing instructions of the computer program(s) executed by the processing unit 210, data generated by the execution of the computer program(s), data received via a communication interface 230 of the survey server 200, etc. The survey server 200 may comprise several types of memories, including volatile memory, non-volatile memory, etc. The survey server 200 further comprises the communication interface 230 (e.g. Wi-Fi interface, Ethernet interface, etc.). The communication interface 230 is used for exchanging data with other entities, such as a user device 100 and the profile server 300

The survey server 200 exchanges data with the other entities through communication links, generally referred to as the Internet 10 for simplification purposes. Such communication links may include wired (e.g. a fixed broadband network) and wireless communication links (e.g. a cellular network or a Wi-Fi network).

The survey server 200 may further comprise a display (e.g. a regular screen or a tactile screen) for displaying data generated by the processing unit 210, and a user interface (e.g. a mouse, a keyboard, a trackpad, a touchscreen, etc.) for allowing a user to interact with the survey server 200. The display and the user interface are not represented in FIG. 1 for simplification purposes.

The user device 100 may consist of a desktop or laptop computer, a mobile device (e.g. smartphone, tablet, etc.), an Internet connected television, etc. The user device 100 is capable of retrieving web content from a web server 20 over the Internet 10, and displaying the retrieved web content to a user of the user device 100 via a web browser. The user device 100 comprises a processing unit 110, having one or more processors (not represented in FIG. 1 for simplification purposes) capable of executing instructions of computer program(s) (e.g. the web browser). Each processor may further have one or several cores. The user device 100 also comprises memory 120 for storing instructions of the computer program(s) executed by the processing unit 110, data generated by the execution of the computer program(s), data received via a communication interface 130 of the user device 100, etc. The user device 100 may comprise several types of memories, including volatile memory, non-volatile memory, etc. The user device 100 further comprises the communication interface 130 (e.g. cellular interface, Wi-Fi interface, Ethernet interface, etc.). The communication interface is used for exchanging data over the Internet 10 with other entities, such as the web server 20 and the survey server 200.

The user device 100 further comprises a display 140 (e.g. a regular screen or a tactile screen) for displaying data generated by the processing unit 210, web content retrieved from the web server 20, etc. The user device 100 also comprises a user interface 150 (e.g. a mouse, a keyboard, a trackpad, a touchscreen, etc.) for allowing a user to interact with the user device 100 (e.g. interactions of the user with the displayed web content).

The web server 20 generally consists of a dedicated computer with high processing capabilities, capable of hosting one or a plurality of websites. The web server 20 comprises a processing unit, memory, and a communication interface (e.g. Ethernet interface, Wi-Fi interface, etc.) for delivering web content of a hosted website to the user device 100. The components of the web server 20 are not represented in FIG. 1 for simplification purposes.

Although a single user device 100 is represented in FIG. 1, a plurality of user devices 100 exchange data with the web server 20 in relation to a visit of a specific website (hosted by the web server 20) by the plurality of user devices 100.

The profile server 300 comprises a processing unit 310, having one or more processors (not represented in FIG. 1 for simplification purposes) capable of executing instructions of computer program(s). Each processor may further have one or several cores. The profile server 300 also comprises memory 320 for storing instructions of the computer program(s) executed by the processing unit 310, data generated by the execution of the computer program(s), data received via a communication interface 330 of the profile server 300, etc. The profile server 300 may comprise several types of memories, including volatile memory, non-volatile memory, etc. The profile server 300 further comprises the communication interface 330 (e.g. Wi-Fi interface, Ethernet interface, etc.). The communication interface 330 is used for exchanging data over the Internet 10 with other entities, such as the survey server 200.

Furthermore, the profile server 300 interacts with various entities (e.g. a plurality of web servers 20, a plurality of user devices 100, etc.) via the communication interface 330, to collect data related to the users of the user devices 20, in order to generate an online profile of the users of the user devices 20. The generation of the online profiles will be detailed later in the description.

The profile server 300 may further comprise a display (e.g. a regular screen or a tactile screen) for displaying data generated by the processing unit 310, and a user interface (e.g. a mouse, a keyboard, a trackpad, a touchscreen, etc.) for allowing a user to interact with the profile server 300. The display and the user interface are not represented in FIG. 1 for simplification purposes.

Referring now particularly to FIGS. 2A and 2B, the steps of the method 400 will be described. The method 400 comprises two phases: a learning phase for generating predictive survey participation patterns, and an operational phase for using the generated predictive survey participation patterns.

### Learning Phase (FIG. 2A)

At step 405, web content corresponding to a specific website is transmitted by the web server 20 to a user device 100 over the Internet 10. The specific website is hosted by the web server 20 and visited by a user of the user device 100. The interactions between the user device 100 and the web server 20 for exchanging the web content are well known in the art. The web content is sent via the communication interface (not represented in FIG. 1) of the web server 20 and received via the communication interface 130 of the user device 100. The web content may include text, image(s), video(s), icon(s), etc.

At step 410, the web content is displayed on the display 140 of the user device 100 by the browser executed by the processing unit 110 of the user device 100. During a browsing session of the specific website, a sequence of web pages of the specific website containing the web content is displayed on the display 140. The user of the user device 100 interacts with the web content of the web pages through the user interface 150 of the user device 100. The user interactions may lead to additional web content being transmitted by the web server 20 to the user device 100. Thus, although a single step 405 and a single step 410 are represented in FIG. 2A for simplification purposes, the sequence of steps 405 and 410 is usually repeated according to a progression of the browsing session of the specific website performed by the user of the user device 100.

The user of the user device 100 participates to a web survey related to the visit of the specific website, and provides survey information by participating to the web survey. Usually, only a subset of all the user devices 100 engaged in a browsing session of the specific website participate to the web survey. First, only some of the users of the user devices 100 may be invited by the survey server 200 to participate to the web survey, based on a predefined invitation rate. Then, only some of the invited users of the user devices 100 accept to participate to the web survey and to provide survey information.

At steps 415 and 416, survey participation data are respectively collected by the processing unit 110 of the user device 100, and transmitted by the processing unit 110 from the user device 100 to the survey server 200. The survey participation data correspond to the survey information provided by the user. The survey participation data are sent via the communication interface 130 of the user device 100 and received via the communication interface 230 of the survey server 200.

For simplification purposes, steps 415 and 416 have been represented after steps 405 and 410 in FIG. 2A. However, steps 415 and 416 may occur at any time during the browsing session of the specific website (e.g. at the beginning, in the middle, or at the end). Furthermore, the collection of survey participation data may occur with respect to a particular web page of the specific website being displayed, or with respect to a plurality of web pages being displayed.

An example of survey participation data comprises responses to a survey questionnaire related to the visited specific website, and includes at least one of the following: free-form text, ratings, selection of one or more elements among proposed alternatives, ordering of proposed elements, etc. An invitation to participate to the web survey may be prompted to the user of the user device 100 during the visit of the specific website, voluntarily triggered by the user of the user device 100 (e.g. through the selection of a survey icon), communicated to the user of the user device 100 in a delayed manner (e.g. through an email), etc.

Users of several user devices 100 participate to the web survey related to the specific website, and the several user devices 100 generate corresponding survey participation data. The processing unit 210 of the survey server 200 collects the survey participation data from the several user devices, for further processing at step 425 of the method 400.

The survey participation data are received via the communication interface 230 of the survey server 200 and stored in the memory 220 for later use. Furthermore, the survey participation data of a specific user device 100 may be received in several bundles, and aggregated in the memory 220 using a unique identifier of the specific user device 100.

The processing unit 210 of the survey server 200 may also filter the collected survey participation data, and discard some of them based on pre-determined criteria. The criteria may include at least one of the following: incomplete data, erroneous data, irrelevant data, etc.

At step 420, the processing unit 210 of the survey server 200 collects online profile data related to the user of the user device 100 from the profile server 300, for further processing at step 425 of the method 400. The online profile data include at least one attribute representative of an online activity of the user of the user device 100. The online activity generally includes a plurality of websites visited by the user of the user device 100, and the online profile data are not limited to data (e.g. behavioral data) related only to the specific website for which the survey participation data are collected. Details on the online profile data and the possible attributes will be given later in the description.

Online profile data may be collected by the survey server 200 for each user device 100 for which survey participation data have been collected at steps 415 and 416. Alternatively, online profile data are only collected by the survey server 200 for a subset of the user devices 100 for which survey participation data have been collected at steps 415 and 416. The subset of the user devices 200 is determined based on one or more criteria, such as accuracy and/or relevancy of the collected survey participation data for each user device 100.

The effective collection of the online profile data is generally performed by the profile server 300. An online profile is generated by the profile server 300 for the user devices 100 for which online profile data have been collected. The online profile is stored by the profile server 300. Thus, collection of the online profile data by the survey server 200 generally simply consists in the transmission of the online profile stored at the profile server 300 to the survey server 200.

A common unique identifier of the user devices 100 is used by the survey server 200 and the profile server 300 for identifying each user device 100. For privacy issues, the unique identifier is generally an anonymized unique identifier, generated based on a user device specific identifier, such as a Media Access Control (MAC) address in the case of a computer, an International Mobile Subscriber Identity (IMSI) or International Mobile Station Equipment Identity (IMEI) in the case of a smartphone, etc.

At step 415, the user device specific identifier of the user device 100 is collected along with the survey participation data, and transmitted at step 416 to the survey server 200. The survey server 200 generates the unique identifier of the user device 100 based on the user device specific identifier. The step of generating the unique identifier at the survey server 200 is not represented in FIG. 2A for simplification purposes. Alternatively, the unique identifier of the user device 100 is generated by the user device 100 itself, and transmitted to the survey server 200.

At step 420, the survey server 200 sends a request (not represented in FIG. 2A for simplification purposes) to the profile server 300, with the unique identifier of the user device 100 for which survey participation data have been collected. The profile server 300 transmits the online profile data corresponding to the unique identifier of the user device 100 to the survey server 200. In some cases, the profile server 300 may not have online profile data corresponding to the unique identifier of the user device 100, in which case the corresponding collected survey participation data cannot be used at step 425 of the method 400.

The effective collection of online profile data by the profile server 300 for generating an online profile for at least some of the user devices 100 will be detailed later in the description. The unique identifier of the user device 100 is also used by the profile server 300 for uniquely identifying each user device 100. Thus, all the collected online profile data corresponding to a specific user device 100 are stored by the profile server 300, referenced by the unique identifier of the specific user device 100, and transmitted upon request from the profile server 300 to the survey server 200.

The online profile data are sent via the communication interface 330 of the profile server 300 and received via the communication interface 230 of the survey server 200. The received online profile data are stored in the memory 220 of the survey server 200 for later use. Furthermore, the online profile data of a specific user device 100 may be received in several bundles, and aggregated in the memory 220 using the unique identifier of the specific user device 100. The processing unit 210 of the survey server 200 may also filter the received online profile data, and discard some of them based on pre-determined criteria. The criteria may include at least one of the following: incomplete data, erroneous data, irrelevant data, etc.

At step 425, the processing unit 210 of the survey server 200 analyzes the survey participation data and the corresponding online profile data to generate predictive survey participation patterns for the specific website. As mentioned previously, a unique identifier is used by the survey server 200 for uniquely identifying each specific user device 100. This unique identifier allows the survey server 200 to associate the survey participation data collected for a particular user device 100 visiting the specific website with the corresponding online profile data collected for the particular user device 100.

Step 425 is performed when a sufficient amount of survey participation data and corresponding online profile data have been collected from the user devices 100. Correlations between the survey participation data and the corresponding online profile data are inferred by the processing unit 210 of the survey server 200 through analysis of these data. The predictive survey participation patterns are generated based on these correlations. Taking into consideration the predictive survey participation patterns, and having only online profile data for a particular user device 100, corresponding predicted survey participation data in relation to the specific website can be extrapolated for the particular user device 100.

For example, the user of the particular user device 100 may be currently visiting the specific website, and the predicted survey participation data can be used for personalizing the content of the specific website, to adapt this content to predicted user preferences or expectations inferred via the predicted survey participation data. Alternatively, the user of the particular user device 100 is not currently visiting the specific website, and the predicted survey participation data are used for selecting an advertisement targeted to the specific website, for influencing the user to visit the specific website. For instance, the predicted survey participation data comprise a predicted user intent in relation to the specific website, which is used for selecting an advertisement adapted to the predicted user intent. The two previous examples are for illustration purposes only, and are not intended to limit the usage of the predicted survey participation data.

Techniques for the determination of correlations between two sets of data, and the generation of predictive patterns based on the correlations, is well known in the art of data analysis, and is out of the scope of the present disclosure. For instance, statistical and/or artificial intelligence (e.g. machine learning) techniques can be used for this purpose.

At step 450 (represented in FIG. 2B), the processing unit 210 of the survey server 200 stores the generated predictive survey participation patterns in the memory 220, for use in the operational phase.

In a particular aspect, the survey information provided by the user of the user device 100 when participating to the web survey is at least partially related to an intent of the user for visiting the specific website. For instance, the web survey includes one or more questions related to the intent of the user.

Step 425 comprises determining by the processing unit 210 of the survey server 200 an intent of the users of the user devices 100 in relation to the visiting of the specific website, based on the collected survey participation data. Step 425 further comprises analyzing by the processing unit 210 the determined intent of the users and the corresponding online profile data, to generate predictive user intent patterns.

Examples of user intent include information, price learning, purchase, account management, user support, etc. The user intent being information corresponds to a user visiting the specific website for obtaining general information about a product, a service, etc. presented on the specific website. The user intent being price learning corresponds to a user visiting the specific website for obtaining specific information related to the price of a product, a service, etc. presented on the specific website. The user intent being purchase corresponds to a user visiting the specific website for purchasing a product, a service, etc. available through the specific website. The user intent being account management corresponds to a user visiting the specific website for creating/managing a user account on the specific website. The user intent being support corresponds to a user visiting the specific website for obtaining support via the specific website for a product or service previously purchased by the user.

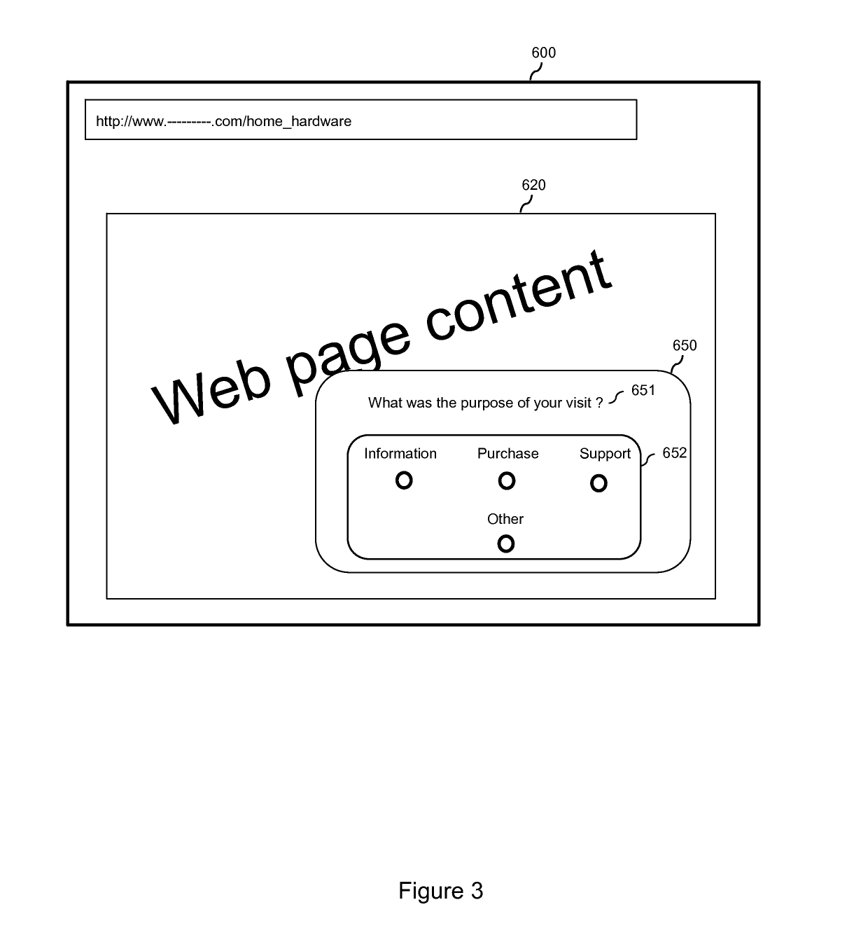

Other types of user intent may be determined based on the collected survey participation data, such as for example: a purpose of visit, a purchase horizon, a purchase stage, a channel of choice (e.g. online versus offline), an intent of travel (e.g. business versus leisure), etc. The present method 400 can be applied to a variety of websites, and for each specific website, a list of relevant user intents can be determined based on the specificities of the specific website. The list of relevant user intents can be submitted to a visitor of the specific website via a survey, as illustrated in FIG. 3, to collect survey participation data comprising the user intent.

FIG. 3 illustrates an example of a web survey comprising a question for determining the intent of the users in relation to the visit of the specific website. A Graphical User Interface 600 of the browser executed by the processing unit 110 of the user device 100 displays web content related to the visited specific website on the display 140 of the user device 100. A GUI 650 for allowing the user of the user device 100 to provide the survey information is also displayed on the display 140. For example, the GUI 650 consists in an overlay popup window partially covering a browsing window 620 containing the displayed web content (e.g. web page home_hardware of the visited specific website).

A survey content displayed in the overlay popup window 650 comprises a closed-ended question 651 related to the intent of the user, and a selection widget 652 comprising four selectable items (information, purchase, support, other) corresponding to an intent of the user.

The interactions of the user with the GUI 650 (e.g. selection of one of the four items of the selection widget 652) generate survey participation data representative of the intent of the user for visiting the specific website. The survey participation data may comprise a value selected among pre-defined values (e.g. 1 for information, 2 for purchase, 3 for support, 4 for other) corresponding to the user intent.

In the embodiment illustrated in FIG. 3, upon reception of the survey participation data, the survey server 200 directly extracts the intent of the user from the survey participation data. In an alternative embodiment, the web survey does not include a question directly related to the intent of the user. Consequently, the intent of the user is inferred from the survey participation data, rather than being directly extracted from the survey participation data. For this purpose, at least some of the survey participation data are processed by the processing unit 210 of the survey server 200, to determine the intent of the user. This processing for determining the intent of the user is out of the scope of the present disclosure, but is well known in the art of analyzing survey participation data.

In another particular aspect, the survey information provided by the user of the user device 100 when participating to the web survey is at least partially related to an experience of the user for visiting the specific website. For instance, the web survey includes one or more questions related to the experience of the user. For example, the user experience may be expressed via one of the following ratings: excellent, good, neutral, bad, and awful.

Step 425 comprises determining by the processing unit 210 of the survey server 200 an experience of the users of the user devices 100 in relation to the visiting of the specific website, based on the collected survey participation data. Step 425 further comprises analyzing by the processing unit 210 the determined experience of the users and the corresponding online profile data, to generate predictive user experience patterns for the specific website.

In still another particular aspect, the survey information provided by the user of the user device 100 when participating to the web survey is at least partially related to a brand perception by the user visiting the specific website. The visited specific website provides information on products or services associated to the brand, and/or offers for sales these products or services. For example, the brand perception may be expressed via one of the following ratings: excellent, good, neutral, bad, and awful.

Step 425 comprises determining by the processing unit 210 of the survey server 200 a brand perception by the users of the user devices 100 in relation to the visiting of the specific website, based on the collected survey participation data. Step 425 further comprises analyzing by the processing unit 210 the determined brand perception of the users and the corresponding online profile data, to generate predictive brand perception patterns for the specific website.

In yet another particular aspect, the survey information provided by the user of the user device 100 when participating to the web survey is at least partially related to a brand recall by the user visiting the specific website. The visited specific website provides information on products or services associated to the brand, and/or offers for sales these products or services. Brand recall generally measures how well a brand name is connected with a product type or class of products by consumers.

Step 425 comprises determining by the processing unit 210 of the survey server 200 a brand recall by the users of the user devices 100 in relation to the visiting of the specific website, based on the collected survey participation data. Step 425 further comprises analyzing by the processing unit 210 the determined brand recall of the users and the corresponding online profile data, to generate predictive brand recall patterns for the specific website.

As mentioned previously, the online profile data include at least one attribute representative of the online activity of the user of the user device 100. Examples of attributes include one or more Uniform Resource Locators (URLs) corresponding to visited web pages, one or mode domain names corresponding to visited websites, one or more times of day, one or more locations, environment variables, one or more segment identifiers, etc. The URLs correspond to web pages visited by the user of the user device 100 during its online activity. The domain names correspond to websites visited by the user of the user device 100 during its online activity. The online profile data may include only URLs of visited web pages, only domain names of visited websites, or a combination of the two. The time of day corresponds to the time at which another particular attribute has been collected. For example, the time of day indicates at which time an URL or a domain name has been collected, which in turn indicates at which time the user of the user device 100 has visited the corresponding web page or website. The location indicates a location of the user device 100 (e.g. country, region, city, etc.). The environment variable indicates a characteristic of the user device 100, for instance a hardware characteristic or a software characteristic. For example, what language is used by the operating system of the user device 100, what brand of operating system is used, what brand of browser is used by the user device 100, what is the size of the screen of the user device 100.

The segment identifier corresponds to a particular segment identified by its unique segment identifier. The profile server 300 generates various segments based on data collected during the online activity of the users. Each segment may be representative of an interest of the user for a particular category among a list of predefined categories. The interest can be determined based on data collected by the profile server 300 while the user is browsing through a plurality of websites. For instance, the list of categories of interest includes online banking, sports, home decoration, music, online shopping, news, weather, etc. The segments can be defined by a combination of several categories of interest. For example, a segment combines an interest for online banking and online shopping, a segment combines an interest for sports and news, etc. Alternatively or complementarity, the segments may be based on demographic information of the users (e.g. age, sex, marital status, profession, etc.), The demographic information can be collected by the profile server 300 via a dedicated web survey submitted to the users of the user devices 100, asking questions aimed at gathering a demographic profile of the users.

In a particular aspect, the online profile data of a user only consist of a segment identifier. Various segments, each having a unique segment identifier, are generated and stored by the profile server 300. Each specific segment comprises a plurality of user devices 100, which have been determined to meet specific criteria for being part of the specific segment, based on data collected by the profile server 300 during the online activity of the user devices 100. Thus, the predictive survey participation patterns are generated by the survey server 200 via a correlation of the segment identifiers with the survey participation data.

In another particular aspect, the online profile data of a user consist of a segment identifier and at least one additional attribute. For example, the at least one additional attribute may include one of the following: time of day, location, environment variable, or a combination thereof. Thus, the predictive survey participation patterns are generated by the survey server 200 via a correlation of the segment identifiers and associated at least one attributes with the survey participation data.

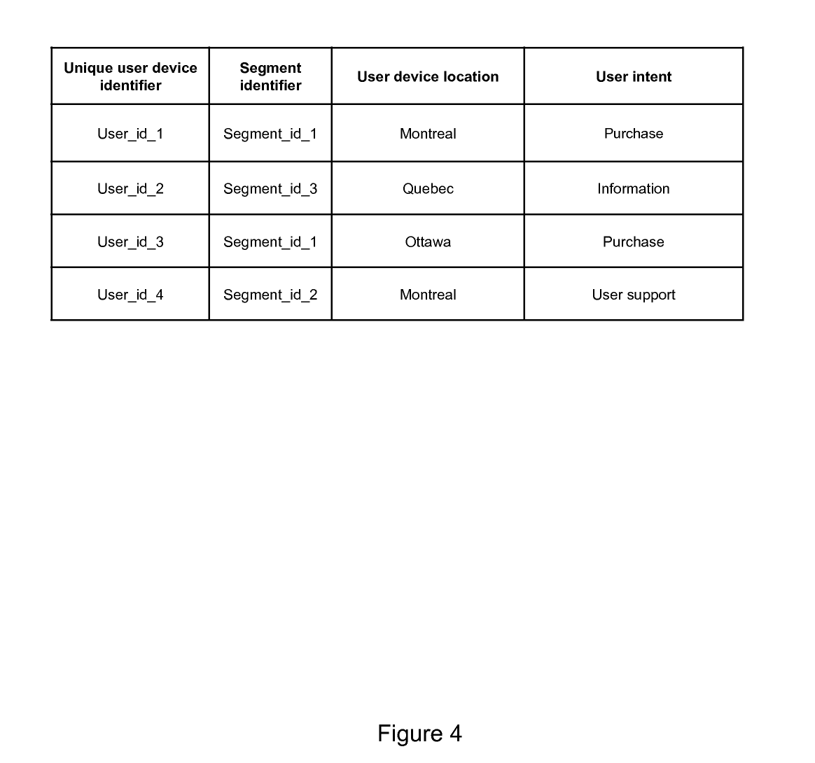

FIG. 4 represents an example of data collected by the survey server 200, which are grouped based on the unique identifier of the user devices 100, stored in the memory 220 of the survey server 200, and processed by the processing unit 210 of the survey server 220 for generating the predictive survey participation patterns. The online profile data for each user device 100 consist of a segment identifier and a location of the user device 100. The survey participation data for each user device 100 consist of a user intent. In this case, the generated predictive survey participation patterns (not represented in FIG. 4) consist of predictive user intent patterns. FIG. 4 illustrates a potential correlation between the segment identifier “segment_id_1” and the user intent being “purchase”.

The collection of the online profile data by the profile server 300 may be implemented via various techniques well known in the art. For example, a dedicated cookie can be installed on the user devices 100. While the users of the user devices 100 are browsing a plurality of websites (as part of their online activity), the dedicated cookies collect data of interest and transmit these data to the profile server 300. The profile server 300 generates the online profiles of the users based on the data of interest transmitted by the dedicated cookies. Alternatively or complementarily, the profile server 300 may implement, or may be connected to, a Deep Packet Inspection (DPI) functionality. DPI is well known in the art, and consists in analyzing various protocol layers (e.g. various Internet Protocol (IP) layers) of packets exchanged between the user devices 100 and web servers (or other networking equipment), to extract and collect data of interest, which can be further used for generating the online profiles of the users.

In a particular embodiment, the profile server 300 may consist of an advertisement server. Advertisement servers are well known in the art for generating online profiles of users, based on data transmitted by dedicated cookies installed on the user devices of the users.

In another particular embodiment, the profile server functionality 300 is directly implemented by the survey server 200.

### Operational Phase (FIG. 2B)

During the operational phase, the predictive survey participation patterns generated at step 425 and stored at step 450 are used to generate predicted survey participation data for users of current user devices 100 in relation to the specific website for which the predictive survey participation patterns have been generated.

The user of the current user device 100 has not participated to a web survey related to a visit of the specific website, and consequently has not provided survey information by participating to the web survey. For example the user of the current user device 100 has visited the specific website, but has not been invited by the survey server 200 to participate to the web survey. Alternatively, the user of the current user device 100 has been invited, but has refused to participate to the web survey. In still another alternative, the user of the current user device 100 has not even visited the specific website.

At step 460, the processing unit 210 of the survey server 200 collects current online profile data related to the user of the current user device 100 from the profile server 300, for further processing at step 465 of the method 400. As mentioned previously, the current online profile data include at least one attribute representative of an online activity of the user of the current user device 100. As mentioned previously, collection of the current online profile data by the survey server 200 generally simply consists in the transmission of a current online profile stored at the profile server 300 to the survey server 200. This step is similar to step 420.

As mentioned previously, at step 460, the survey server 200 sends a request (not represented in FIG. 2B for simplification purposes) to the profile server 300, with the unique identifier of the current user device 100 for which survey participation data are not available. In response to the request, the profile server 300 transmits the current online profile data corresponding to the unique identifier of the current user device 100 to the survey server 200. The current online profile data are sent via the communication interface 330 of the profile server 300 and received via the communication interface 230 of the survey server 200. The received current online profile data may be stored in the memory 220 of the survey server 200 for later use.

Although not represented in FIG. 2B for simplification purposes, a request comprising the unique identifier of the current user device 100 is transmitted (before step 460) to the survey server 200 by an entity to which the predicted survey participation data generated at step 465 are further transmitted in response to the request. For instance, the entity may be the current user device 100 or an advertisement server, as will be illustrated later in the description.

The processing unit 210 of the survey server 200 may also filter the received current online profile data, and discard some of them based on pre-determined criteria. The criteria may include at least one of the following: incomplete data, erroneous data, irrelevant data, etc. In particular, if some of the received current online profile data do not correspond to the type of online profile data collected at steps 420 for the learning phase, they are discarded. The current online profile data need to be of the same type/same scope as the online profile data collected for the learning phase in order to obtain a relevant result at step 2465.

At step 465, the processing unit 210 of the survey server 200 generates predicted survey participation data for the current user device 100 in relation to the specific website, based on the current online profile data (collected at step 460) and the predictive survey participation patterns (generated at step 425 and stored at step 450). Step 465 leverages the learning phase, by using the predictive survey participation patterns to infer the predicted survey participation data, when the effective collection of survey participation data in relation to the specific website for the current user device 100 has not been performed.

Although the learning phase and the operational phase have been represented sequentially in FIGS. 2A and 2B for simplification purposes, they may also occur simultaneously. For instance, the learning phase may be performed solely until satisfying predictive survey participation patterns have been generated at step 425 of the method 400. For example, the generated predictive survey participation patterns are satisfying if they allow to generate predicted survey participation data at step 465 of the method 400 with a pre-defined level of accuracy (e.g. 95% of the predicted survey participation data are accurate). Then, the operational phase is performed, but the learning phase can still be performed simultaneously to improve/update predictive survey participation patterns generated at step 425 of the method 400.

In a previously mentioned particular aspect, the survey information provided at step 415 by the user of the user device 100 when participating to the web survey were at least partially related to an intent of the user for visiting the specific website; and the predictive survey participation patterns generated at step 425 and stored at step 450 comprise predictive user intent patterns.

Thus, generating at step 465 predicted survey participation data for the current user device 100 in relation to the specific website, based on the current online profile data (collected at steps 460) and the predictive survey participation patterns comprises determining a predicted intent of the user of the current user device in relation to the specific website.

For example, the predicted intent may consist of a predicted purchase intent, indicative of a predicted intent of the user of the current user device to purchase product(s) and/or service(s) available on the specific website. The predictive survey participation patterns and corresponding predicted intent may further include several sub-categories related to a purchase intent, such as for example consideration stage (the probability that the user of the current user device will proceed to a purchase is low or medium) and purchase stage (the probability that the user of the current user device will proceed to a purchase is high).

In another previously mentioned particular aspect, the survey information provided at step 415 by the user of the user device 100 when participating to the web survey were at least partially related to an experience of the user when visiting the specific website; and the predictive survey participation patterns generated at step 425 and stored at step 450 comprise predictive user experience patterns.

Thus, generating at step 465 predicted survey participation data for the current user device 100 in relation to the specific website, based on the current online profile data (collected at steps 460) and the predictive survey participation patterns comprises determining a predicted experience of the user of the current user device in relation to the specific website.

In still another previously mentioned particular aspect, the survey information provided at step 415 by the user of the user device 100 when participating to the web survey were at least partially related to a brand perception by the user visiting the specific website; and the predictive survey participation patterns generated at step 425 and stored at step 450 comprise predictive brand perception patterns.

Thus, generating at step 465 predicted survey participation data for the current user device 100 in relation to the specific website, based on the current online profile data (collected at steps 460) and the predictive survey participation patterns comprises determining a predicted brand perception by the user of the current user device in relation to the specific website.

In yet another previously mentioned particular aspect, the survey information provided at step 415 by the user of the user device 100 when participating to the web survey were at least partially related to a brand recall by the user visiting the specific website; and the predictive survey participation patterns generated at step 425 and stored at step 450 comprise predictive brand recall patterns.

Thus, generating at step 465 predicted survey participation data for the current user device 100 in relation to the specific website, based on the current online profile data (collected at step 460) and the predictive survey participation patterns comprises determining a predicted brand recall by the user of the current user device in relation to the specific website.

As mentioned previously, the online profile data of the training phase (FIG. 2A) as well as the current online profile data of the operational phase (FIG. 2B) include at least one attribute representative of the online activity of the user of the user device 100, and examples of attributes include Uniform Resource Locators (URLs) of visited web pages, domain names of visited websites, times of day, locations, environment variables, segment identifiers, etc.

In a previously mentioned particular aspect, the online profile data of the training phase (FIG. 2A) as well as the current online profile data of the operational phase (FIG. 2B) only consist of a segment identifier. Thus, the predicted survey participation data for the current user device in relation to the specific website are generated based on the segment identifier of the current online profile data and the predictive survey participation patterns.

In another previously mentioned particular aspect, the online profile data of the training phase (FIG. 2A) as well as the current online profile data of the operational phase (FIG. 2B) consist of a segment identifier and at least one additional attribute. Thus, the predicted survey participation data for the current user device in relation to the specific website are generated based on the segment identifier and the at least one additional attribute of the current online profile data and the predictive survey participation patterns.

In still another particular aspect, during the learning phase, the survey participation data collected from the plurality of user devices 100 (steps 415 and 416) correspond to a plurality of websites visited by the users of the user devices 100. For example, the plurality of websites belong to the same industry (e.g. automotive, travel agencies, etc.), and respectively correspond to several brands of a same company (e.g. several brands of cars from the same auto manufacturer). Thus, the mechanism (e.g. statistical and/or artificial intelligence method) for predicting (at step 465) survey participation data based on current online profile data and predictive survey participation patterns is trained (at step 425) with survey participation data from the plurality of websites. The predictive survey participation patterns can then be used at step 465 for generating the predicted survey participation data based on the collected current online profile data, for any of the plurality of websites.

In yet another particular aspect and referring concurrently to FIGS. 1 and 2A, during the learning phase, the method 400 also comprises the step of collecting, by the processing unit 210 of the survey server 200, behavioral data from the plurality of user devices 100. The behavioral data are representative of a series of actions performed by the users of the plurality of user devices 100 in relation to the visiting of the specific web site. Behavioral data are well known in the art, and include for example visited web pages, time spent on the visited web pages, specific interactions with the visited web pages, etc. The collection of behavioral data is also well known in the art. Then, at step 425 of the method 400, the collected behavioral data are taken into consideration by the processing unit 210 of the survey server 200, which performs an analysis of the survey participation data, the online profile data, and the behavioral data to generate the predictive survey participation patterns for the specific website. Thus, the collected behavioral data are used to complement the collected online profile data. The additional use of the collected behavioral data at step 425 may allow the generation of more accurate predictive survey participation patterns, generally at the cost of a more complex processing.

Then, referring concurrently to FIGS. 1 and 2B, during the operational phase, the method 400 also comprises the step of receiving, by the processing unit 210 of the survey server 200, current behavioral data for a current user device 100. The current behavioral data are representative of a series of actions performed by the user of the current user device 100 in relation to the visiting of the specific web site. Then, at step 465 of the method 400, the received current behavioral data are taken into consideration by the processing unit 210 of the survey server 200, which generates the predicted survey participation data for the current user device in relation to the specific website based on the current online profile data, the current behavioral data, and the predictive survey participation patterns. Thus, the current behavioral data are used to complement the current online profile data. The additional use of the current behavioral data at step 465 may allow the generation of more accurate predicted survey participation data, generally at the cost of a more complex processing.

The present disclosure also relates to a non-transitory computer program product comprising instructions for implementing steps of the method 400, when executed by the processing unit 210 of the survey server 200. The instructions are comprised in the computer program product (e.g. memory 220), and provide for generating predictive survey participation patterns using online profile data, when executed by the processing unit 210. The instructions comprised in the computer program product are deliverable via an electronically-readable media, such as a storage media (e.g. a USB key or a CD-ROM) or communication links (e.g. via the Internet 10 through the communication interface 230 of the survey server 200).

The execution of the instructions provides for collecting participation data from a plurality of user devices 100 (steps 415 and 416). The survey participation data correspond to survey information received from users of the plurality of user devices 100 in relation to the visiting of a specific website.

The execution of the instructions provides for collecting online profile data for the plurality of user devices 100 (step 420). The online profile data comprise at least one attribute representative of an online activity of the users of the plurality of user devices 100.

The execution of the instructions provides for analyzing the survey participation data and the online profile data to generate predictive survey participation patterns for the specific website (step 425).

The execution of the instructions provides for receiving current online profile data for a current user device 100 (step 460). The current online profile data comprise at least one attribute representative of an online activity of a user of the current user device 100.

The execution of the instructions provides for generating predicted survey participation data for the current user device in relation to the specific website based on the current online profile data and the predictive survey participation patterns (step 465).

### Use of the Predicted Survey Participation Data for Advertising

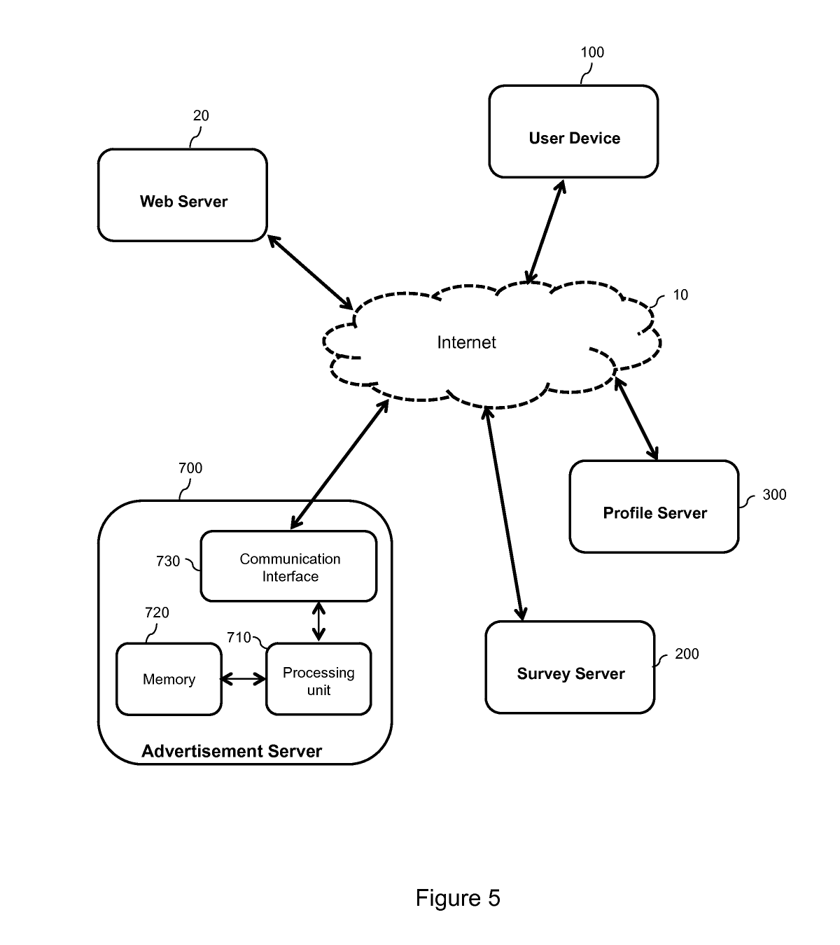

Reference is now made concurrently to FIGS. 1, 2B, 2C, 2D and 5. FIGS. 2C and 2D illustrate a particular usage of the predictive survey participation patterns generated at step 425 for advertising, for an advertisement server 700 represented in FIGS. 2C, 2D and 5.

In the context of advertising, instead of performing step 465 illustrated in FIG. 2B, the survey server 200 performs step 465′ illustrated in FIGS. 2C and 2D. Step 465′ consists in generating an indicator of predicted survey participation data, instead of generating the predicted survey participation data as per step 465. The indicator introduces an abstraction level between the survey server 200 and the advertisement server 700. For instance, a particular advertisement server 700 may not be capable of directly interpreting the predicted survey participation data generated at step 465 for the purpose of selecting an advertisement. Thus, the survey server 200 generates at step 465′ an indicator representative of the predicted survey participation data, which can be interpreted by the advertisement server 700 for selecting an advertisement. This allows the survey server 200 to interact with a plurality of advertisement servers 700, by generating (at step 465′) for each specific advertisement server 700 a particular type of indicator of predicted survey participation data which can be interpreted by the specific advertisement server 700.

The generation at step 465′ of the indicator of predicted survey participation data for the current user device 100 in relation to the specific web site is based on the current online profile data for the current user device 100 received by the survey server 200 at step 460 and the predictive survey participation patterns for the specific website generated by the survey server 200 at step 425.

Various types of indicators of predicted survey participation data may be generated at step 465′. In a particular aspect, the indicator of predicted survey participation data directly consists in the predicted survey participation data. In this case, step 465′ is identical to step 465. In another particular aspect, the indicator of predicted survey participation data consists in at least one index representative of the predicted survey participation data. For example, each index may correspond to a segment identifier (also referred to as profile identifier) used by the advertisement server 700 to identify a particular advertising segment (also referred to as advertisement profile), for which particular advertisements are selected for display on the user device 100. The mapping between the predicted survey participation data defined at the survey server 200 level and the indexes (e.g. segment identifiers) defined at the advertisement server 700 level is dependent on a particular implementation of the advertisement server 700.

The advertisement server 700 comprises a processing unit 710, having one or more processors (not represented in FIG. 5 for simplification purposes) capable of executing instructions of computer program(s). Each processor may further have one or several cores. The advertisement server 700 also comprises memory 720 for storing instructions of the computer program(s) executed by its processing unit 710, data generated by the execution of the computer program(s), data received via a communication interface 730 of the advertisement server 700, etc. The advertisement server 700 may comprise several types of memories, including volatile memory, non-volatile memory, etc. The advertisement server 700 further comprises the communication interface 730 (e.g. Wi-Fi interface, Ethernet interface, etc.). The communication interface 730 is used for exchanging data over the Internet 10 with other entities, such as the current user device 100. As is well known in the art, the advertisement server 700 interacts with the current user device 100 over the Internet 10, for delivering advertisement(s) (e.g. a banner, a video, etc.) to the current user device 100, while the user of the current user device 100 is visiting a website hosted by a web server 20. The advertisements are displayed on the display 140 of the current user device 100 along with a web content of the visited web site.

The advertisement server 700 may further comprise a display (e.g. a regular screen or a tactile screen) for displaying data generated by its processing unit 710, and a user interface (e.g. a mouse, a keyboard, a trackpad, a touchscreen, etc.) for allowing a user to interact with the advertisement server 700. The display and the user interface are not represented in FIG. 5 for simplification purposes.

In a particular embodiment, the advertisement server 700 and the profile server 300 are the same entity. In this case, the advertisement server 700 implements the functionality of the profile server 300 consisting in generating and storing the online profile data, and transmitting the online profile data to the survey server 200 at steps 420 and 460.

For illustration purposes, the interactions between the survey server 200, the advertisement server 700 and the current user device 100 will be described in the case where the indicator of predicted survey participation data consist of an indicator of predicted user intent (for example an indicator of predicted purchase intent). However, other types of indicators of predicted survey participation data may be used by the advertisement server 700 for selecting an advertisement to be displayed on the current user device 100.

In a first embodiment illustrated in FIG. 2C, the indicator of predicted user intent generated at step 465′ is transmitted to the advertisement server 700 via the current user device 100.

As mentioned previously, a request (not represented in FIG. 2B for simplification purposes) comprising the unique identifier of the current user device 100 is transmitted (before step 460) by the current user device 100 to the survey server 200. Then, steps 460 and 465′ are performed as previously described.

At step 480, the processing unit 210 of the survey server 200 transmits (via its communication interface, not represented in FIG. 1) the indicator of predicted user intent generated at step 465′ to the current user device 100 over the Internet 10. The indicator of predicted user intent is received by the processing unit 110 of the current device 100 via its communication interface 130. The indicator of predicted user intent can be stored in memory 120 for future use, or can be processed immediately by the processing unit 110.

At step 485, the processing unit 110 of the current user device 100 transmits (via its communication interface 130) the indicator of predicted user intent to the advertisement server 700 over the Internet 10. The indicator of predicted user intent is received by the processing unit 710 of the advertisement server 700 via its communication interface (not represented in FIG. 5). The indicator of predicted user intent can be stored in memory 720 for future use, or can be processed immediately by the processing unit 710.

In a second embodiment illustrated in FIG. 2D, the indicator of predicted user intent generated at step 465′ is directly transmitted to the advertisement server 700.

As mentioned previously, a request (not represented in FIG. 2B for simplification purposes) comprising the unique identifier of the current user device 100 is transmitted (before step 460) by the advertisement server 700 to the survey server 200. Then, steps 460 and 465′ are performed as previously described.

At step 486, the processing unit 210 of the survey server 200 transmits (via its communication interface, not represented in FIG. 1) the indicator of predicted user intent generated at step 465′ to the advertisement server 700 over the Internet 10. The indicator of predicted user intent is received by the processing unit 710 of the advertisement server 700 via its communication interface (not represented in FIG. 5). The indicator of predicted user intent can be stored in memory 720 for future use, or can be processed immediately by the processing unit 710.

At step 490, the processing unit 710 of the advertisement server 700 selects an advertisement directed to the specific website for the current user device 100, based at least on the indicator of predicted user intent transmitted at step 485 (FIG. 2C) or 486 (FIG. 2D). The advertisement server 700 may only take into consideration the indicator of predicted user intent for selecting the advertisement directed to the specific website. Alternatively, the advertisement server 700 takes into consideration the indicator of predicted user intent in combination with other parameter(s) for selecting the advertisement directed to the specific website. The advertisement being directed to the specific website means that the purpose of the advertising is to influence the user of the current user device 100 to visit the specific website. As mentioned previously, the use of the indicator of predicted user intent at step 490 is for illustration purposes only. Any type of indicator of predicted survey participation data generated at step 465′ can be used for selecting the advertisement at step 490.

At step 495, the processing unit 710 of the advertisement server 700 transmits (via its communication interface, not represented in FIG. 5) the selected advertisement to the current user device 100 over the Internet 10. The selected advertisement is received by the processing unit 110 of the current device 100 via its communication interface 130.

At step 500, the processing unit 110 of the current user device 100 displays the selected advertisement on the display 140. The selected advertisement may consist of a banner, a video, a picture, etc. The selected advertisement is displayed when the user of the current user device 100 is visiting a current website, and the displayed advertisement contains content directed to the specific website, for driving the user to visit the specific website. For instance, by clicking on a displayed content of the advertisement, the web browser of the current user device 100 is directed to the specific website.

The advertisement selected at step 490 and displayed at step 500 may consist of a targeting advertisement or a retargeting advertisement. In the case of a targeting advertisement, the user of the current user device 100 has not necessarily visited the specific website, and the targeting advertisement simply aims at directing the user to visit the specific website. In the case of a retargeting advertisement, the user of the current user device 100 has already visited the specific website, and the retargeting advertisement aims at redirecting the user to visit the specific website again.

For illustration purposes, the retargeting advertisement case will now be detailed with respect to the embodiment illustrated in FIG. 2C. The execution of steps 485 and 490 depend on a specific implementation of the interactions between the current user device 100 and the advertisement server 700. For instance, the indicator of predicted user intent is received at step 480 by the current user device 100 following a first visit of the specific website (survey participation data have not been collected during this visit, and thus the indicator of predicted user intent is generated in replacement of the missing survey participation data, as illustrated previously). The indicator of predicted user intent may be stored in a cookie, along with an identifier of the specific website (e.g. its URL). When the user of the current user device 100 visits another website, a script related to the advertisement server 700 is executed by the browser of the current user device 100, sending a request for an advertisement to the advertisement server 700. This request corresponds to step 485, and contains the indicator of predicted user intent and the identifier of the specific website for which the indicator was determined. The request may contain a plurality of identifiers of websites previously visited by the user of the current user device 100, at least one of them having a corresponding indicator of predicted user intent. The advertisement server 700 generally uses a biding algorithm for selecting one among the previously visited websites as candidate for advertisement retargeting (this step is not represented in FIG. 700, since it is well known in the art of retargeted advertisement). If the website selected among the previously visited websites is a specific website for which an indicator of predicted user intent has been generated at step 465′, and transmitted at steps 480 and 485, the advertisement server 700 further uses the indicator of predicted user intent to select a particular retargeting advertisement directed to the specific website (at step 490). Taking into consideration the indicator of predicted user intent allows for a selection of a particular retargeting advertisement more prone to driving the user to visit the specific website again.

Alternatively or complementarily, the selection by the advertisement server 700 of a candidate for advertisement retargeting takes into consideration a plurality of pre-defined websites, each having a particular biding level which may be adjusted in real time. As mentioned previously, when the candidate website for advertisement retargeting is selected among the plurality of pre-defined websites, if a corresponding indicator of predicted user intent for the candidate website is available, is it used at step 490 for selecting a particular retargeting advertisement more prone to driving the user to visit the selected candidate website again.

The indicator of predicted user intent received by the current user device 100 at step 480, during (or after) the visit of the specific website, may be transmitted to the advertisement server 700 (step 485) immediately (along with an identifier of the specific website). The indicator of predicted user intent (along with the identifier of the specific website) is stored in the memory 720 of the advertisement server 700. The indicator of predicted user intent is used later when the current user device 100 visits another website, and requests the advertisement server 700 to select a retargeting advertisement. Alternatively, the indicator of predicted user intent is stored in the memory 120 (e.g. via a cookie) of the current user device 100 (along with an identifier of the specific website). When the current user device 100 visits another website, and requests the advertisement server 700 to select a retargeting advertisement, the indicator of predicted user intent is transmitted to the advertisement server 700 (step 485), along with the identifier of the specific website.

The following examples illustrate the selection at step 480 of a particular retargeting advertisement directed to the specific website based on the indicator of predicted user intent. If the indicator of predicted user intent is an indicator of predicted purchase intent, the objective of the retargeting advertisement is to increase conversion. Consequently, the retargeting advertisement may consist of special offers, promotions, coupons, etc. If the indicator of predicted user intent is an indicator of predicted information intent, the objective of the retargeting advertisement is to perform an effective lead nurturing. Consequently, the retargeting advertisement may be directed to product awareness, product specifications, product options, etc. If the indicator of predicted user intent is an indicator of predicted user support intent, the objective of the retargeting advertisement is to increase customer retention. Consequently, the retargeting advertisement may be directed to support topics, community knowledge, etc.

In a particular aspect, the method 400 comprises determining a bid level based at least on the indicator of predicted user intent of the user of the current device 100. The determination of the bid level can be performed by the processing unit 710 of the advertisement server 700, for example at step 490 of the method 400. The determination of the bid level can also be performed by the processing unit 110 of the current user device 100, for example between steps 480 and 485 of the method 400 (the bid level is then transmitted to the advertisement server 700 at step 485, along with the indicator of predicted user intent). The bid level determines a price that a brand owner is ready to pay for having a retargeting advertisement related to its brand served to the current user device 100 by the survey server 700. The survey server 700 generally implements an auction process, to take into consideration the bid levels offered by the brands for selecting which retargeting advertisement (corresponding to a particular brand) to serve.

For example, if the indicator of predicted user intent is an indicator of predicted purchase intent, the bid level has the highest value since a conversion of the user is the most likely to happen. Decreasing values for the bid level are associated respectively with the indicator of predicted user intent being an indicator of price learning intent, information intent, user support intent and account management intent; since the probably of converting the user decreases accordingly.

In another particular aspect, the selection of the retargeting advertisement directed to the specific website at step 490 of the method 400 also takes into consideration complementary behavioral data collected from the current user device 100 in relation to the initial visit of the specific website. The complementary behavioral data consist in behavioral data collected by the advertisement server 700 for performing standard behavioral retargeting based on collected behavioral data. For example, the advertisement server 700 may determine a candidate indicator of user intent based on the collected complementary behavioral data, and refine/correct the candidate indicator of user intent based on the indicator of predicted user intent transmitted at step 485. Then, step 490 of the method 400 (selection of a retargeting advertisement) is based on the refined/corrected candidate indicator of user intent.

For illustration purposes, the targeting advertisement case will now be detailed with respect to the embodiment illustrated in FIG. 2D. When the user of the current user device 100 visits a website, a script related to the advertisement server 700 is executed by the browser of the current user device 100, sending a request for an advertisement to the advertisement server 700 (step 484). As mentioned previously, the advertisement server 700 generally uses a biding algorithm for selecting one among a plurality of candidate websites for advertisement targeting. If the website selected among the plurality of candidate websites is a specific website for which an indicator of predicted user intent can be generated as per steps 460 and 465′, the indicator of predicted user intent is transmitted at step 486 from the survey server 200 to the advertisement server 700. Although not represented in FIG. 2D for simplification purposes, after step 484, a request is transmitted by the advertisement server 700 to the survey server 200. Following the request, the survey server 200 performs steps 460 and 465′ for generating the indicator of predicted user intent, which is transmitted at step 486. The advertisement server 700 further uses the indicator of predicted user intent to select a particular targeting advertisement directed to the specific website (at step 490). Taking into consideration the indicator of predicted user intent allows for a selection of a particular targeting advertisement more prone to driving the user to visit the specific website.

Alternatively or complementarily, the advertisement server 700 may also use the indicator of predicted user intent for selecting one among the plurality of candidate websites for advertisement targeting. In this case, the advertisement server 200 requests the survey server 200 to transmit indicators of predicted user intents for each of the plurality of candidate websites. The survey server 200 transmits at step 486 the indicators of predicted user intents for specific websites among the plurality of candidate websites (those for which the indicator of predicted user intent can be generated as per steps 460 and 465′). The indicators of predicted user intents for the specific websites can be used as an additional criteria for selecting one among the plurality of candidate websites for advertisement targeting.

As mentioned previously, the use of the indicator of predicted user intent for retargeting advertisement or targeting advertisement is for illustration purposes only. Other types of indicators of predicted survey participation data may also be used independently or in combination, such as an indicator of predicted user experience, an indicator of predicted brand perception, an indicator of predicted brand recall, etc.

In a particular aspect, a single entity simultaneously implements the functionalities of the survey server 200 and the advertisement server 700. For example, a legacy survey server 200 is adapted to perform the functionalities of the advertisement server 700 (e.g. by executing software(s) implementing the functionalities of the advertisement server 700). Alternatively, a legacy advertisement server 700 is adapted to perform the functionalities of the survey server 200 (e.g. by executing software(s) implementing the functionalities of the survey server 200). In this case, the communications between functionalities implemented by the survey server 200 and functionalities implemented by the advertisement server 700 are not performed through the Internet 10, but through internal components of the single entity.

In another particular aspect, a legacy survey server 200 is adapted to perform some of the functionalities of the advertisement server 700. After performing step 465′, the processing unit 210 of the survey server 200 performs the step (not represented in FIGS. 2C and 2D) of selecting an advertisement directed to the current website for the current user device 100 based at least on the indicator of predicted survey participation data generated at step 465′. The processing unit 210 of the survey server 200 further performs the step (not represented in FIGS. 2C and 2D) of transmitting the selected advertisement to one of: the advertisement server 700 or the current user device 100. If the selected advertisement is transmitted to the current user device 100, it can be directly displayed on the display 140 of the current user device 100. If the selected advertisement is transmitted to the advertisement server 700, it is managed by the advertisement server 700 (e.g. determine an appropriate bid level for the selected advertisement), and further transmitted by the advertisement server 700 to the current user device 100 for display on its display 140.

### Use of the Predicted Survey Participation Data for Website Content Personalization

Reference is now made concurrently to FIGS. 1, 2A and 2B, to illustrate another particular usage of the predicted survey participation data generated at step 465, more specifically to perform website content personalization.

After performing step 465, the processing unit 210 of the survey server 200 further processes the predicted survey participation data to generate at least one personalization parameter for the specific website. The at least one personalization parameter is specifically adapted to the user of the current user device 100 for which the predicted survey participation data have been generated at step 465.

The at least one personalization parameter and the unique identifier of the current user device 100 are transmitted by the survey server 200 to the web server 20 hosting the specific website, via their respective communication interfaces over the Internet 10. The at least one personalization parameter and the unique identifier are stored in the memory of the web server 20.

When the user of the current user device 100 visits the specific website hosted by the web server 20, the unique identifier of the current user device 100 is transmitted by the current user device 100 to the web server 20 over the Internet 10. The processing unit of the web server 20 identifies the at least one personalization parameter (associated to the current user device 100 via its unique identifier. The processing unit of the web server 20 uses the at least one personalization parameter to personalize web content corresponding to the specific website, which is transmitted by the web server 20 to the current user device 100 over the Internet 10. The personalized web content is further displayed by the processing unit 110 of the current user device 100 on its display 140. Thus, the browsing experience of the user of the current user device 100 with respect to the specific website is adapted and personalized, based on the predicted survey participation data which have been generated by the survey server 200 at step 465.

Personalization of web content is well known in the art, and comprises for example one of the following: adapting a generic web content into a personalized web content based on one or more personalization parameters, selecting a particular web content among several candidate web contents based on one or more personalization parameters, etc. Furthermore, the personalization of the web content may comprise adapting the design (e.g. format, appearance, etc.) of a particular web page, adapting the informative content (e.g. text, image, video, etc.) provided by a particular web page, and a combination thereof.

As illustrated previously, various types of predicted survey participation data may be used independently or in combination, such as predicted user intent (e.g. predicted purchase intent), predicted user experience, predicted brand perception, predicted brand recall, etc. For each type of predicted survey participation data, corresponding personalization parameter(s) are generated by the survey server 200.

For instance, if the predicted survey participation data consist in a predicted user intent (such as information, purchase, user support), the personalization parameters may determine the design and informative content of the home page and/or landing page of the specific website.

If the predicted survey participation data consist in a predicted brand perception or predicted brand recall, the personalization parameters may determine the design and informative content of one or more web pages of the specific website, in order to improve the brand perception or brand recall of the user of the current user device 100 with respect to the brand corresponding to the specific website.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. A survey server comprising:
a communication interface for exchanging data with other devices;
memory for storing predictive survey participation patterns; and
a processing unit for:
collecting survey participation data from a plurality of user devices, the survey participation data corresponding to survey information received from users of the plurality of user devices in relation to the visiting of a specific website;
collecting online profile data for the plurality of user devices, the online profile data comprising at least one attribute representative of an online activity of the users of the plurality of user devices;
analyzing the survey participation data and the online profile data to generate predictive survey participation patterns for the specific website;
receiving current online profile data for a current user device, the current online profile data comprising at least one attribute representative of an online activity of a user of the current user device; and
generating an indicator of predicted survey participation data for the current user device in relation to the specific website based on the current online profile data and the predictive survey participation patterns.

2. The survey server of claim 1, wherein the indicator of predicted survey participation data consists in the predicted survey participation data.

3. The survey server of claim 1, wherein the indicator of predicted survey participation data consists in at least one index representative of the predicted survey participation data.

4. The survey server of claim 1, wherein the processing unit transmits the indicator of predicted survey participation data to one of: an advertisement server, or the current user device.

5. The survey server of claim 1, wherein the processing unit further:
selects an advertisement directed to the current website for the current user device based at least on the indicator of predicted survey participation data; and
transmits the selected advertisement to one of: an advertisement server, or the current user device.

6. The survey server of claim 1, wherein the processing unit further determines an intent of the users of the plurality of user devices in relation to the visiting of the specific website based on the survey participation data;
the predictive survey participation patterns for the specific website consist in predictive user intent patterns generated by analyzing the intent of the users and the online profile data; and
the indicator of predicted survey participation data for the current user device in relation to the specific website consists in an indicator of predicted user intent generated based on the current online profile data and the predictive user intent patterns.

7. The survey server of claim 6, wherein the indicator of predicted user intent consists in an indicator of predicted purchase intent.

8. The survey server of claim 1, wherein the processing unit further determines an experience of the users of the plurality of user devices in relation to the visiting of the specific website based on the survey participation data;
the predictive survey participation patterns for the specific website consist in predictive user experience patterns generated by analyzing the experience of the users and the online profile data; and
the indicator of predicted survey participation data for the current user device in relation to the specific website consists in an indicator of predicted user experience generated based on the current online profile data and the predictive user experience patterns.

9. The survey server of claim 1, wherein the processing unit further determines a brand perception by the users of the plurality of user devices in relation to the visiting of the specific website based on the survey participation data;
the predictive survey participation patterns for the specific website consist in predictive brand perception patterns generated by analyzing the brand perception of the users and the online profile data; and
the indicator of predicted survey participation data for the current user device in relation to the specific website consists in an indicator of predicted brand perception generated based on the current online profile data and the predictive brand perception patterns.

10. The survey server of claim 1, wherein the processing unit further determines a brand recall by the users of the plurality of user devices in relation to the visiting of the specific website based on the survey participation data;
the predictive survey participation patterns for the specific website consist in predictive brand recall patterns generated by analyzing the brand recall of the users and the online profile data; and
the indicator of predicted survey participation data for the current user device in relation to the specific website consists in an indicator of predicted brand recall generated based on the current online profile data and the predictive brand recall patterns.

11. An advertisement server comprising:
a communication interface for exchanging data with other devices; and
a processing unit for:
receiving an indicator of predicted survey participation data for a current user device in relation to a specific website from one of: a survey server or the current user device, the indicator of predicted survey participation data being generated by the survey server based on current online profile data of the current user device and predictive survey participation patterns for the specific web site generated by the survey server; and
selecting an advertisement directed to the current website for the current user device based at least on the indicator of predicted survey participation data.

12. The advertisement server of claim 11, wherein the indicator of predicted survey participation data consists in one of: the predicted survey participation data, or at least one index representative of the predicted survey participation data.

13. The advertisement server of claim 11, further comprising transmitting the selected advertisement from the advertisement server to the current user device.

14. A method for generating an indicator of predicted survey participation data, comprising:
collecting by a processing unit of a survey server survey participation data from a plurality of user devices, the survey participation data corresponding to survey information received from users of the plurality of user devices in relation to the visiting of a specific website;
collecting by the processing unit online profile data for the plurality of user devices, the online profile data comprising at least one attribute representative of an online activity of the users of the plurality of user devices;
analyzing by the processing unit the survey participation data and the online profile data to generate predictive survey participation patterns for the specific website;
receiving by the processing unit current online profile data for a current user device, the current online profile data comprising at least one attribute representative of an online activity of a user of the current user device; and
generating by the processing unit an indicator of predicted survey participation data for the current user device in relation to the specific website based on the current online profile data and the predictive survey participation patterns.

15. The method of claim 14, wherein the indicator of predicted survey participation data consists in the predicted survey participation data.

16. The method of claim 14, wherein the indicator of predicted survey participation data consists in at least one index representative of the predicted survey participation data.

17. The method of claim 14, further comprising transmitting by the processing unit the indicator of predicted survey participation data to one of: an advertisement server, or the current user device.

18. The method of claim 14, further comprising:
selecting by the processing unit an advertisement directed to the current website for the current user device based at least on the indicator of predicted survey participation data; and
transmitting by the processing unit the selected advertisement to one of: an advertisement server, or the current user device.

19. The method of claim 14, further comprising:
determining by the processing unit an intent of the users of the plurality of user devices in relation to the visiting of the specific website based on the survey participation data;
wherein the predictive survey participation patterns for the specific website consist in predictive user intent patterns generated by analyzing the intent of the users and the online profile data; and
the indicator of predicted survey participation data for the current user device in relation to the specific website consists in an indicator of predicted user intent generated based on the current online profile data and the predictive user intent patterns.

20. The method of claim 19, wherein the indicator of predicted user intent consists in an indicator of predicted purchase intent.
